(19) United States
(12) Patent Application Publication
(10) Pub. No.: US 2008/0087490 A1
(43) Pub. Date: Apr. 17, 2008

(54) Control element for regulating a heating, ventilation, or air conditioning unit of a motor vehicle

(76) Inventors: Wolfgang Kuechler, Ostheim (DE); Rocco Mertsching, Munnerstadt (DE)

Correspondence Address: MG-IP Law, PLLC, P.O. BOX 1364, FAIRFAX, VA, 22038-1364, US

(21) Appl. No.: 11/865,709

(22) Filed: Oct. 1, 2007

Related U.S. Application Data
(63) Continuation of application No. PCT/EP2006/002808, filed on Mar. 28, 2006.

(30) Foreign Application Priority Data
Mar. 29, 2005 (DE) DE 102005014198

(51) Int. Cl. B60H 1/00; B60K 37/06

(52) U.S. Cl. 180/334

(57) ABSTRACT

A control element is provided for a motor vehicle having a rotary control which is held in a panel and is designed to be rotatable about its center axis and can move horizontally from the center axis into distinguishable switch positions as well as vertically, and by which a parameter of a heating, ventilation and air conditioning unit of the motor vehicle can be adjusted in each switch position or displaced position wherein the rotary control can be moved in any desired direction within a gate to distinguishable switch positions, and the rotary control is provided with a first coupling element, and in each switch position the first coupling element is connected to another coupling element associated with the switch position, so that an adjustment of the parameters of the heating, ventilation and air conditioning system is made possible by the rotary control in the relevant switch position.

This nonprovisional application is a continuation of International Application No. PCT/EP2006/002808, which was filed on Mar. 28, 2006, and which claims priority to German Patent Application No. DE 102005014198, which was filed in Germany on Mar. 29, 2005, and which are both herein incorporated by reference.

### BACKGROUND OF THE INVENTION

1. Field of the Invention

The present invention relates to a control element for a motor vehicle having a rotary control which is held in a panel, is designed to be rotatable about its center axis, can move horizontally from the center axis into distinguishable switch positions as well as vertically, and by means of which a parameter of a heating, ventilation and air conditioning unit of the motor vehicle can be adjusted in each switch position or displaced position.

2. Description of the Background Art

Control elements for controlling heat, ventilation and air conditioning in a motor vehicle typically are placed in an instrument panel and typically are arranged in a manner that is ergonomically suited to the driver. In this regard, the instrument panel usually contains a number of measurement indicators and control elements merely for controlling the heat, ventilation and air conditioning. Thus, for example, a rotary stepping switch for the fan, a selector slide or rotary knob for the temperature, and one or more slides or rotary controls for the air outlets are present. In the case of simple mechanical systems for heat, ventilation and air conditioning control, various Bowden cables and/or flexible shafts known as flex shafts are used for this purpose. Each Bowden cable or flex shaft is operated by a specific rotary control or slide lever. The selected setting is displayed on this adjusting element by a pointer or marking, while the individual functions are indicated by printed symbols on a panel of the control element or the instrument panel or on the adjusting element.

In order to improve clarity in controlling the heating and ventilation system in a motor vehicle, a multifunction control element is described in DE 199 29 294 A1. In this control element, a first adjusting element in an operating plane is designed as a slide function of another adjusting element in the operating plane. As a result of this control element, the number of control elements in the instrument panel is reduced, making the instrument panel more straightforward. A different function is associated with the rotary control in each switch position of the control element. Examples of these functions are the temperature, the choice of air outlet, or the airflow quantity. While the functional assignment of individual switch positions to different functions of the control element is described in this document, no indication is given in this document that such a control element can be used for controlling Bowden cables or flex shafts.

Multifunction control elements for controlling Bowden cables and/or flex shafts are known from U.S. Pat. No. 3,286,044 and DE 15 755 92 A1, for example. In both systems, the adjustment of a heating, ventilation, and air conditioning system is accomplished by a control knob that rotates about its center axis and can be moved horizontally in a gate and into and out of the gate. In both systems, the movement of the control knob in the control element results in a mechanical adjustment of the elements of the heating, ventilation and air conditioning system. However, neither of these systems provides an indication that different functions can be assigned to the different displacement positions or switch settings.

### SUMMARY OF THE INVENTION

It is therefore an object of the present invention to provide a control element for a motor vehicle with which multiple functions can be performed by a rotary control in a control element in order to optimize the available space, and which, moreover, provides a simple mechanical system for operating a wide variety of control and regulating devices in a motor vehicle with minimal design effort and minimum cost.

The inventive object is attained in that the rotary control can be moved in any desired directions within a gate to distinguishable switch positions, and in that the rotary control is provided with a first coupling element, and in that in each switch position the first coupling element is connected to another coupling element associated with the switch position, so that an adjustment of at least one parameter of the heating, ventilation and air conditioning system is made possible in the relevant switch position by means of the rotary control. The inventive concept now makes it possible with the simplest mechanical means to provide a control element that permits adjustment of the heating, ventilation and air conditioning system through displacement into different switch positions and the coupling of the rotary control of the control element to another coupling element by means of a coupling element in this switch position.

In an embodiment of the invention, the control element has a gate in which the rotary control can be brought into distinguishable, permanently predeterminable switch positions. The rotary control is positioned in these switch positions by means of magnetic and/or electric force, thus ensuring a clear assignment of the switch position and, in addition, optimal force transmission into the mechanical system. It is possible in accordance with the invention to assign a display to each switch position so that the setting of the individual parameters of the heating, ventilation and air conditioning system is also displayed visually to the user. For example, the temperature, airflow quantity, selected air outlet, fan levels, or measured, derived or preseftable values of the air conditioning system can be displayed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a front view of a rotary control as well as an arrangement of the individual coupling elements with respect to the setting of the rotary control, according to an embodiment of the present invention;

FIG. 2 shows a side view of the schematic representation of a rotary control with coupling elements from FIG. 1 in a view A-A′; and

FIG. 3 shows a front view of a control element with a cruciform gate and the display devices assigned to the respective switch positions, according to an embodiment of the present invention.

### DETAILED DESCRIPTION

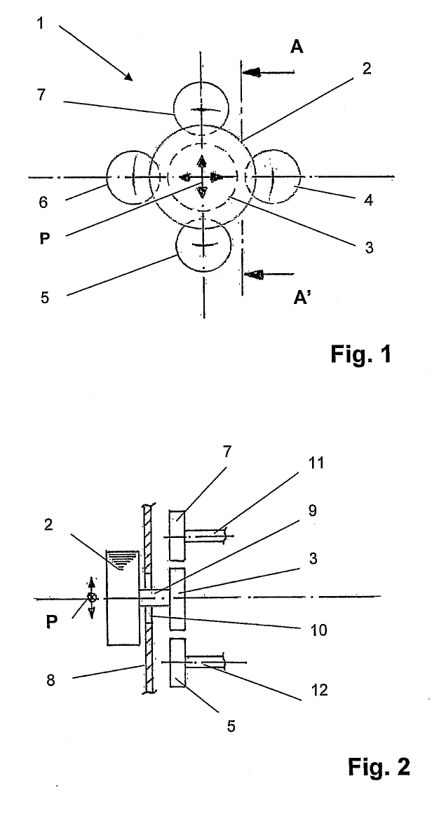

In FIG. 1, a front view of a control unit 1 is shown, with only a rotary control 2 with a first coupling element 3 arranged on the rotary control 2 and four additional coupling elements 4, 5, 6 and 7 being shown here. This schematic diagram of a control element 1 illustrates the functional principle of the coupling of the rotary control 2 in the individual switch positions, in each of which a connection is established between the coupling element 3 of the rotary control 2 and one of the other coupling elements 4, 5, 6 or 7. As a result of displacement of the rotary control 2 in the direction of the arrow P, the rotary control makes mechanical contact with one of the additional coupling elements 4, 5, 6 or 7. In this embodiment four additional coupling elements 4, 5, 6 and 7 are shown, so four different parameters or adjusting elements of a heating, ventilation and air conditioning system can be adjusted by this control element.

FIG. 2 shows a side view of the control element from FIG. 1 in a view A-A′. The rotary control 2 as a part of the control element 1 projects out of a panel 8, wherein the panel is a separate panel 8 of the control element 1 or, for example, is a part of an instrument panel 8 of a motor vehicle. Proceeding from the rotary control 2, a shaft 9 projects through the panel 8 and is connected to the first coupling element 3 at least by friction. An opening 10 that forms a gate 10, in which the rotary control 2 is movably held, is provided in the panel 8 here. When the rotary control 2 is displaced in a direction of the arrow P and vertically toward the additional coupling element 7, the first coupling element 3 engages the additional coupling element 7. According to the invention, it is possible in this regard to provide the coupling elements 3, 4, 5, 6, and 7 with gear teeth, so that during the aforementioned displacement of the rotary control 2 toward the additional coupling element 7 the two gears 7 and 3 mesh, permitting transmission of force, in the form of a rotary motion of the rotary control 2, to the additional coupling element 7. For further transmission of the force, a flexible shaft 11, or a Bowden cable 11 in the form of an additional mechanism, is attached to the additional coupling element 7.

In one embodiment of the invention, it is possible to adapt a mechanism for opening or closing the fresh air supply to the motor vehicle passenger compartment to this flexible shaft 11 or the Bowden cable 11. Naturally, it is equally possible here for multiple air intake flaps to be movable by a flexible shaft 11. It is further possible to operate a temperature regulator, for example, by the above-described coupling element 3, 7, which in this form represents a transmission 3, 7.

If the rotary control 2 is now moved in the vertical direction P within the gate 10 toward the additional coupling element 5, the first coupling element 3 comes into frictional engagement with the additional coupling element 5. In accordance with an object of the invention, it is possible in this regard to manufacture the first coupling element 3 and all the additional coupling elements 4, 5, 6, and 7 as plastic gears 3, 4, 5, 6, and 7. This would implement a cost-effective, advantageous inventive solution. When the first coupling element 3 as a gear 3 is engaged with the additional coupling element 5, then a mechanical adjustment of a parameter of the motor vehicle's heating, ventilation, and air conditioning system can likewise be performed by means of the second gear 5 through a flexible shaft 12. For example, it would be possible here to switch between fresh air and air recirculation. Although it is primarily mechanical components in the motor vehicle's heating, ventilation, and air conditioning system that can be adjusted according to the invention by means of the flexible shafts 11, 12, it is equally possible according to the invention to parameterize electrical components by the additional coupling elements 4, 5, 6, and 7.

The rotary control 2 is guided in a gate 10 in the individual switch positions in the direction of the arrows P. The rotary control 2 is held in the selected switch positions by means of electrical and/or magnetic and/or electromagnetic forces, so that slip-free transmission of force between the coupling elements 3, 4, 5, 6, and 7 is ensured at all times. These positioning elements are not reproduced in this schematic drawing; customary elements for fixing and positioning, such as a metallic shaft in combination with electromagnets, are possible here.

The rotary control 2 is designed to be rotatable about its center axis 13. The rotary control is preferably made of plastic. However, it is equally possible according to the invention to make the rotary control 2 of metal or a plastic with a metallic surface or a plastic with a metallic appearance. Preferably the components of the control element 1 are made of plastic, but metallic materials may also be used as required by the design.

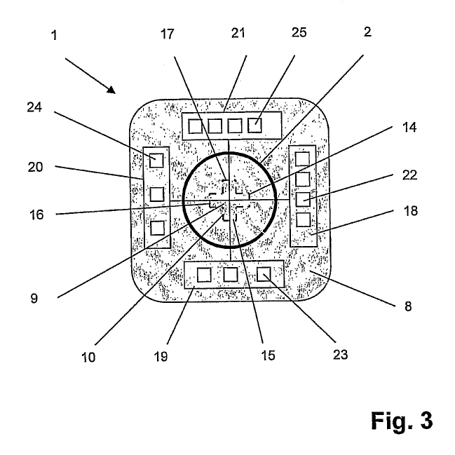

In FIG. 3 a control element 1 is shown in front view. The control element 1 consists essentially of a rotary control 2, a panel 8, a gate 10 incorporated in the panel; a shaft 9 passes through said gate and can be guided into the various switch positions 14, 15, 16 and 17. In this example embodiment, a separate display 18, 19, 20, 21 is assigned to each switch position 14, 15, 16 and 17. The control element further consists of the coupling elements 3, 4, 5, 6 and 7, and the flexible shafts 11, 12 molded onto the coupling elements 3, 4, 5, 6 and 7. This listing of the components of the control element 1 is not exhaustive, and is limited merely to the essential components of the control element 1 necessary for the invention. It is naturally also possible to attach electrical modules to the control element or to integrate them into the control element 1.

If the rotary control 2 is now pushed in a horizontal direction toward the switch position 14, the coupling element 3 then engages with the additional coupling element 4. The display unit 18 is mechanically or electromechanically or electrically connected to this additional coupling element 4. It is possible for the display 18 to be equipped with luminous means 22, which may be light emitting diodes (LEDs), for example. In a variant embodiment, it is possible to actuate a switch by the additional coupling element 4, so that a corresponding display value 22 can be displayed visually in accordance with the adjustment of the parameters of the heating, ventilation and air conditioning system. However, it is equally possible to directly actuate a rotatable printed disk by means of the additional coupling element 4, in order to thus visually indicate a rotation of the additional coupling element 4 by means of an opening 22 provided in the panel 8. This adjustment of the additional coupling element 4 can take place directly, through a disk attached to the additional coupling element 4, or can also take place by means of an additional shaft attached to the coupling element 4.

Essentially, however, a flexible shaft or a Bowden cable 11, 12 is attached to each additional coupling element 4, 5, 6 and 7, in order to thus mechanically adjust a parameter of the heating, ventilation and air conditioning system.

If the rotary control is now pushed in the horizontal direction toward the additional coupling element 6, then the switch position 16 on the control element is selected. By means of the coupling element 3, the rotary control 2 now stands in connection with a Bowden cable or a flexible shaft attached to the additional coupling element 6. If the rotary control 2 is now rotated through an angle, a rotation of the coupling element 3 takes place at the same time, and consequently also a rotation of the additional coupling element 6, which in turn actuates the flexible shaft or the Bowden cable. A wide variety of parameters in the heating, ventilation and air conditioning system can be adjusted by means of the Bowden cable or flexible shaft. Thus, for example, the temperature, airflow quantity, choice of air outlet, level selector switch for the fan, air distribution level, air recirculation or fresh air, or other parameters of the air conditioning system can be mechanically adjusted. The value of the parameter settings is indicated in the display 20. This is accomplished by a switch, for example, by means of which the individual light emitting diodes in the display 20 can be controlled. The display 20, and also the displays 18, 19 and 21, are only shown schematically here. It is a matter of course and self-evident that other arrangements with a plurality of luminous means may also be used. Moreover, pictograms, numbers, or alphanumeric characters may also be displayed by means of backlighting. In addition, the number of luminous means 22, 23, 24 and 25 shown in FIG. 3 is not restrictive.

In another embodiment of the invention, it is possible to integrate a momentary switch in the rotary control 2. It is possible in this way to integrate an additional function in the rotary control. According to the invention, this pushbutton switch can be of a one-piece or multiple-piece design and can be backlighted.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control element for a motor vehicle comprising a rotary control that is held in a panel and is rotatable about a center axis of the rotary control, and is moved horizontally from the center axis into distinguishable switch positions as well as is moved vertically,
wherein, via the rotary control, a parameter for a heating, ventilation and air conditioning unit of the motor vehicle is adjusted in each switch position or displaced position,
wherein the rotary control is moved in any desired directions within a gate to distinguishable switch positions,
wherein the rotary control is provided with a first coupling element, and
wherein, in each switch position, the first coupling element is connected to another coupling element associated with the switch position so that an adjustment of the parameters via the rotary control is made possible in the relevant switch position.

2. The control element according to claim 1, wherein the gate has at least two different switch positions.

3. The control element according to claim 1, wherein the rotary control is held magnetically and/or electrically and/or electromagnetically in the switch positions of the gate.

4. The control element according to claim 1, wherein at least one display is provided in the control element and wherein the display, in a switch position, is adjusted by via the coupling element associated with the switch position.

5. The control element according to claim 4, wherein a display is associated with each switch position.

6. The control element according to claim 4, wherein the display is composed of a plurality of luminous device and wherein each luminous device is controlled by a switch and the coupling element associated with the display.

7. The control element according to claim 6, wherein each luminous device is a light emitting diode.

8. The control element according to claim 1, wherein the first and each additional coupling element has cooperating gear teeth, in particular a gear wheel.

9. The control element according to claim 1, wherein a Bowden cable or flexible shaft is attached to at least one of the coupling elements associated with the switch position.

10. The control element according to claim 1, wherein at least one pushbutton in the form of a key is integrated in the rotary control.

11. The control element according to claim 4, wherein the display includes a rotatable, printed disk that is provided behind a panel of the control element.
